(19) United States
(12) Patent Application Publication
(10) Pub. No.: US 2019/0112199 A1
(43) Pub. Date: Apr. 18, 2019

(54) DISPENSER FOR MAGNETIC TREATMENT OF WATER

(71) Applicant: FROST WATER AS, FREDRIKSTAD (NO)

(72) Inventors: Jon Asle RIVELSRUD, EIKSMARKA (NO); Peder Ragnvald KØLTZOW, SNARØYA (NO)

(73) Assignee: FROST WATER AS, FREDRIKSTAD (NO)

(21) Appl. No.: 16/089,803

(22) PCT Filed: Apr. 7, 2017
(86) PCT No.: PCT/NO2017/050083

§ 371 Date: Sep. 28, 2018

(30) Foreign Application Priority Data
Apr. 7, 2016 (NO) 20160569

(51) Int. Cl. C02F 1/00; C02F 1/48

(52) U.S. Cl. CPC C02F 1/003; C02F 1/481; C02F 2301/026; C02F 2307/10; C02F 2201/48

(57) ABSTRACT

A water dispenser for magnetic treatment of water, comprising a cylinder (4) defining a chamber (3), a bottom part (2) with an opening for leading water into the chamber (3), and a top part (16) with an opening for leading water out of the dispenser (1). A central pillar (5) inside the cylinder (4) and reaching upward from the bottom part (2) holds one or more magnets (6) which create a magnetic field through which water must pass after being fed into the chamber (3) before it can be led out of the opening in the top part (16). A filter holder (7) may be positioned on top of the pillar (5) and configured to hold a filter (15) through which water must pass between the chamber (3) and the opening in the upper part (16).

The present invention relates to a dispenser for magnetic treatment of water, in particular drinking water.

### BACKGROUND OF THE INVENTION

Magnetic treatment of water has for many years been a technique employed in order to prevent build-up of scale in pipes. More recently, it has been discovered that water has various properties that may influence the human body's ability to utilize it and that these properties may be influenced by magnetism.

One such property is water clusters. A water cluster is an assembly of water molecules held together by hydrogen bonds. Water clusters range from the water dimer (H₂O)₂ to clusters of hundreds of molecules and more. Such clusters have been found experimentally as well as being predicted based on computer simulations, but they are poorly understood, and a lot of research remains to be performed in order to better understand the nature of water clusters and how they are associated with many unexplained characteristics of water. Conceptually, water clusters are considered to be discrete, but an alternative understanding of water is one of a loosely-connected network of molecules that may be interpreted as one huge cluster with bonds that are continually rearranged.

It has been theorized that large water clusters do not hydrate cells in the human body as efficiently as smaller clusters. According to this theory, breaking up large water clusters by subjecting them to a magnetic field will produce water that is more beneficial for the body. However, this effect is difficult to measure directly. Also, due to the poor understanding of how water clusters are formed and how stable they are, it is difficult to say anything about how lasting the effect is once the water is removed from the magnetic field.

Consequently, more research is necessary, and it is desirable to design double blind experiments where water that has been subjected to a magnetic field is made readily available to large groups of people, while water that has not been subjected to a magnetic field is made available in exactly the same way to a control group.

### SUMMARY OF THE INVENTION

The need described above is addressed by the present invention in the form of a water dispenser with relatively modest dimensions and the capability of subjecting drinking water to a magnetic field with known and consistent properties. Water delivered from such dispensers can be used in order to perform large scale experiments on the effects of treatment of drinking water with magnetic fields. The dispenser may, of course, also be used outside the context of controlled experiments, for example by people who choose to presume that the advantages of magnetically treated water are beneficial before the theory is scientifically proven or disproven. As such, the invention does not rely on whether or not the effects of magnetically treated water on the human body are real/significant or not, but on the need to provide such water in a convenient manner in order to perform further studies.

A water dispenser for magnetic treatment of water, may comprise a cylinder defining a chamber, a bottom part with an opening for leading water into the chamber, a central pillar inside the cylinder reaching upward from the bottom part, one or more magnets inside the central pillar, and a top part with an opening for leading water that has passed through the filter out of the dispenser.

The bottom part may include a nozzle with a direction that is sufficiently close to horizontal and to being parallel to the walls of the cylinder to cause water to rotate inside the cylinder when it streams into the chamber. In some embodiments the diameter of the nozzle is dimensioned to allow formation of gas bubbles in the water inside the chamber as a result of the drop in pressure from one side of the nozzle to the other.

In some embodiments, the one or more magnets are two magnets positioned adjacent to each other in the vertical direction with the same polarity facing each other.

The water dispenser may further comprise a filter holder positioned on top of the pillar and configured to hold a filter. The filter holder is configured to allow water to pass through the filter and towards the opening in the upper part of the dispenser. The filter holder may be configured to hold a cylindrical filter between an upper part of the filter holder and a lower part of the filter holder such that water passes from the outside of the cylindrical filter to the inside of the cylindrical filter, and an opening of the upper part of the filter holder is aligned with the inside of the cylindrical filter and with the opening in the upper part of the dispenser.

Although the various components of the water dispenser may be constructed and assembled in numerous ways, in some embodiments the upper part of the dispenser is releasably attached to the cylinder and the cylinder is releasably attached to the bottom part of the dispenser. These components may, for example, be provided with matching threads, clamps, bayonet mounts or the like. Similarly, the pillar can be releasably attached to the bottom part of the dispenser by a method selected from the group consisting of: a threaded pin that can be screwed into the bottom part, a smooth pin that can be entered into a corresponding hole in the bottom part, and a socket in the bottom part configured to receive the pillar and prevent it from sideways motion.

According to some embodiments of the invention, the upper part of the pillar, above the magnets, can be provided with one or more openings leading into an interior room such that any content inside the interior room will be in contact with the water in the chamber.

The water dispenser may further comprise a spout connected to the opening in the upper part (16) of the dispenser.

### LIST OF DRAWINGS

FIG. 1 shows a view of a water dispenser according to the invention;

FIG. 2 shows a nozzle which in some embodiments are provided in the bottom part of the dispenser;

FIG. 3 shows detailed views of a central pillar of the dispenser; and

FIG. 4 is a side view of the upper portion of a water dispenser according to the invention.

### DETAILED DESCRIPTION

In the following description of various embodiments, reference will be made to the drawings, in which like reference numerals denote the same or corresponding elements. The drawings are not necessarily to scale. Instead, certain features may be shown exaggerated in scale or in a somewhat simplified or schematic manner, wherein certain conventional elements may have been left out in the interest of exemplifying the principles of the invention rather than cluttering the drawings with details that do not contribute to the understanding of these principles.

It should be noted that, unless otherwise stated, different features or elements may be combined with each other whether or not they have been described together as part of the same embodiment below. The combination of features or elements in the exemplary embodiments are done in order to facilitate understanding of the invention rather than limit its scope to a limited set of embodiments, and to the extent that alternative elements with substantially the same functionality are shown in respective embodiments, they are intended to be interchangeable, but for the sake of brevity, no attempt has been made to disclose a complete description of all possible permutations of features.

Furthermore, those with skill in the art will understand that the invention may be practiced without many of the details included in this detailed description. Conversely, some well-known structures or functions may not be shown or described in detail, in order to avoid unnecessarily obscuring the relevant description of the various implementations. The terminology used in the description presented below is intended to be interpreted in its broadest reasonable manner, even though it is being used in conjunction with a detailed description of certain specific implementations of the invention.

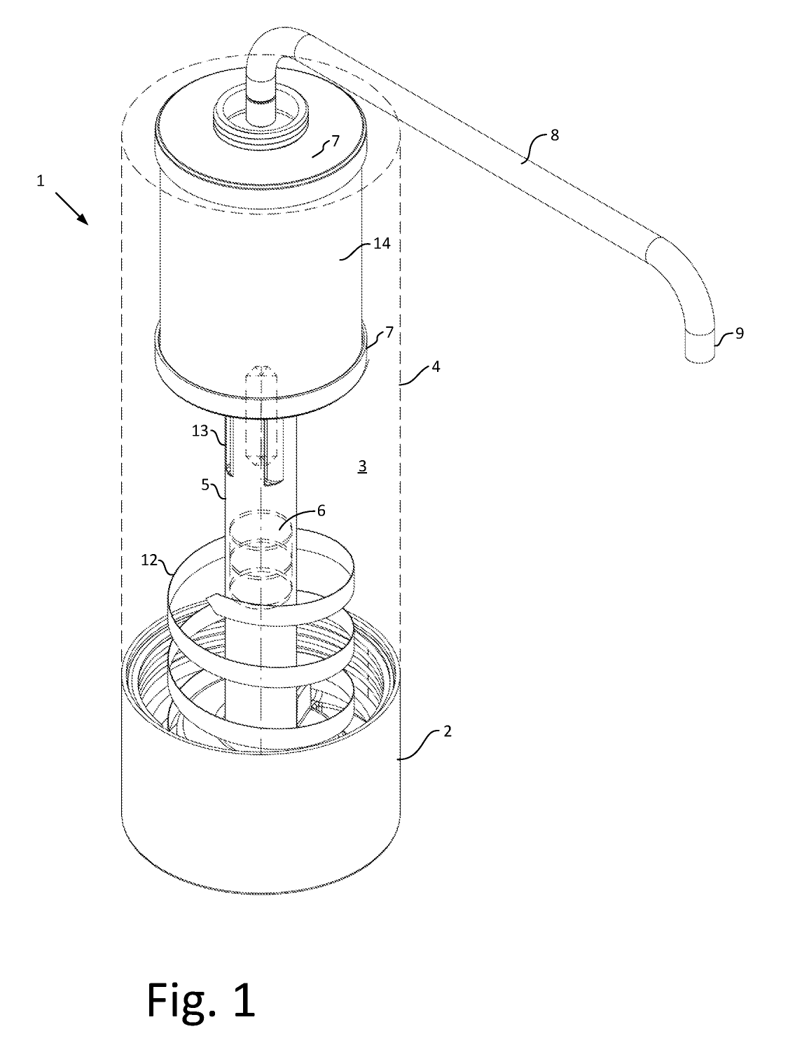

Reference is first made to FIG. 1 which shows a view of a water dispenser 1 according to the invention. The dispenser includes a bottom part 2, which may include well known components for connecting the dispenser to a water feed line (water supply). Such components are well known to those with skill in the art, and they are not shown in the drawing. The feed line may include a valve (not shown) for turning the supply of water on and off. However, the valve may equally well be integrated in the dispenser, allowing the dispenser to operate as a complete faucet.

The bottom part 2 of the dispenser 1, apart from holding the components connecting the dispenser to a water feed line or pipe, includes an opening which leads the water into the water chamber 3 defined by a cylinder 4 (shown with dashed lines) which is removably attached to the bottom part 2. The cylinder 4 and bottom part 2 may be supplied with threads such that the cylinder can be screwed into the bottom part. Alternatively, the cylinder 4 and the bottom part 2 may be provided with a spring loaded bayonet mount, with clips or with any other suitable type of attachment device known in the art.

From the center of the bottom part 2 a rod shaped pillar 5 is provided. The pillar 5 should substantially be concentric with the cylinder 4. The pillar 5, which will be described in further detail below, serves several purposes. It holds the magnets 6 that produce the magnetic field through which the water passes, while also serving as a support for a filter holder 7. From filter holder 7 a spout 8 leads the water out of the dispenser, optionally through an aerator 9.

The filter holder 7 is shown as two separate parts between which a filter 15 is provided. Other configurations are possible. For example, the filter holder could be a filter box that contained the entire filter 15 but had defined openings through which water could enter.

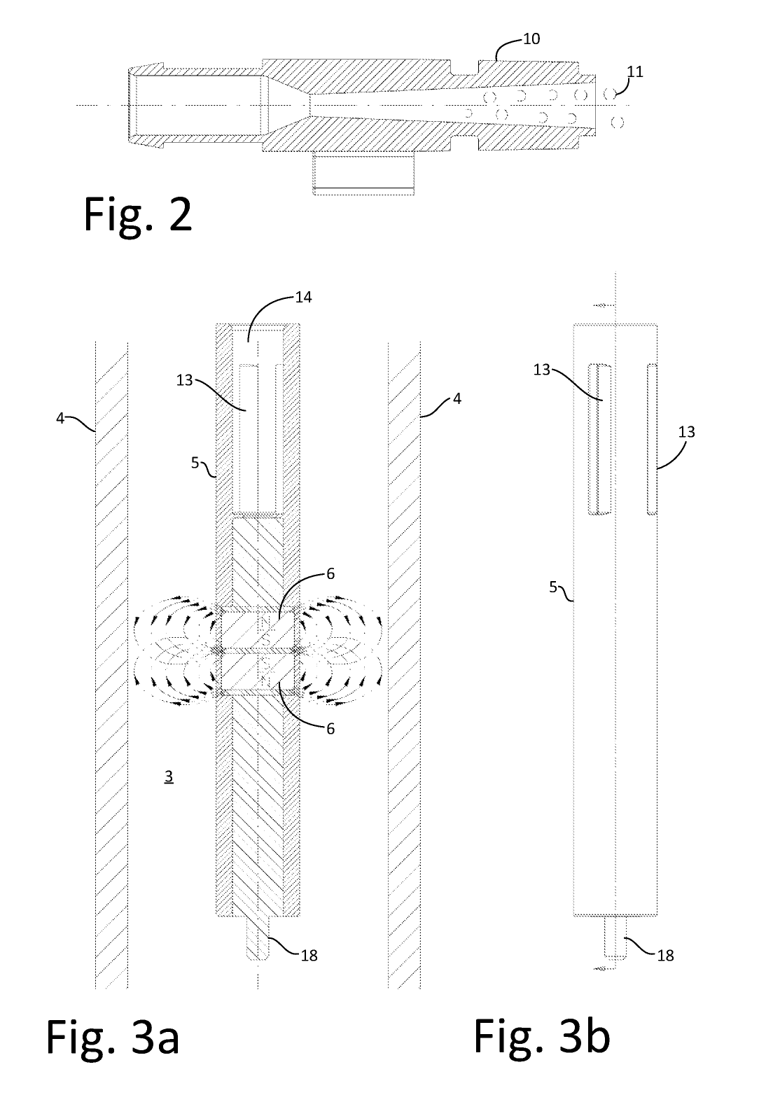

Reference is now made to FIG. 2, which shows a nozzle or jet 10 which in some embodiments are provided in the bottom part 2 at the inlet for water from the feed line and into the chamber 3 of the dispenser 1. The nozzle may be provided almost horizontally and parallel to the outer walls of the bottom part 2. Using a nozzle or jet like this may result in the following effects. First of all, the fact that the pressure will be much higher before the nozzle than after the water has passed through the nozzle may result in small bubbles of air 11 being formed as a result of the sudden drop in pressure. Secondly, the direction and speed of the water that enters the chamber 3 through the nozzle 10 may result in a vortex, i.e. the water will start circulating inside the chamber 3, as indicated by the spiral 12 shown in FIG. 1. The presence of the bubbles will make this circular or spiraling motion of the water visible from the outside in embodiments where the cylinder 4 is made from a transparent material. This may create a pleasing visual effect, and furthermore, it may ensure that all the water is equally exposed to the magnetic field, something that might not be the case if the water is led directly into the chamber 3 in an upward direction, in which case some water may be caught in turbulent motion that keeps it trapped inside the chamber while some water passes more directly from the bottom of the chamber 3 to the top where it enters the filter holder 7.

Formation of air bubbles 11, or any other gas bubbles for that matter, is of course dependent on the presence of dissolved gas in the water fed into the dispenser 1 and the magnitude of the drop in pressure. This, again, depends on the pressure in the water feed line and the resistance to flow through the dispenser and out the spout 8 and out the aerator 9.

Turning now to FIG. 3, the central pillar 5 is shown in a cutaway view in FIG. 3a and in a side view in FIG. 3b. FIG. 3a also includes parts of the cylinder 4, and the chamber 3. Inside the pillar 5 two magnets 6 are provided. These are the magnets 6 that create the magnetic field through which the water passes. In the embodiment illustrated in the drawing two magnets are provided, and they are oriented with their magnetic south poles turned towards each other. The superposition of the fields of the two magnets will then result in a magnetic field that is substantially horizontally symmetrical. Other configurations of magnets are, of course, consistent with the principle of the invention. In some embodiments the pillar may be configured to allow replacement of the magnets in order to allow experimentation with different magnets. Of course, the magnets may also be removed entirely, or pillars without magnets may be provided, in order to enable double blind testing.

Above the magnets 6 a number of openings 13 (also illustrated in FIG. 1) leading into a small interior room 14 or hollow portion inside the top of the pillar. This room can be filled with objects that slowly dissolve and release material into the water, such as e.g. minerals, salts, aromas or anything else that may interact with the water upon contact. Provided that the openings 13 are large enough or the pillar, or part of the pillar, is transparent, the room 14 may also contain objects that are merely decorative.

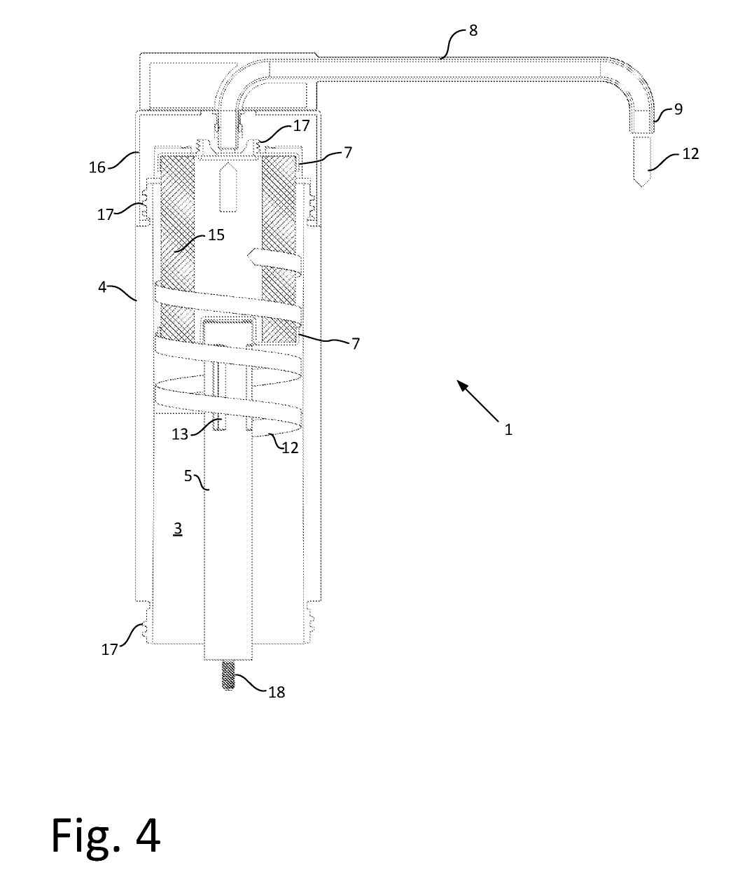

FIG. 4 is a side view of the upper portion of the dispenser 1. The upper portion includes the filter holder 7. Inside the filter holder a cylindrical filter 15 is provided. Water 12 that spirals up the inside of the cylinder 4 will enter through the outside of the cylindrical filter 15. The filter 15 is held in place between the two parts of the filter holder 7. The lower part of the filter holder 7 is resting on top of the pillar 5 while the upper part of the filter holder 7 is pressed down on the filter 15 by a top part 16 of the dispenser. The top part 16 may be releasably attached to the cylinder 4, for example by way of threads 17, just like the cylinder is releasably attached to the bottom part 2.

After the water 12 has passed through the filter 15, the pressure inside the chamber 3 forces the water upward, into the spout 8 and out of the aerator 9.

The upper part of the filter holder 7, or the entire filter holder if it is constructed as one integral part, may be removably attached to the top part 16 of the dispenser 1 by threads 17 or some other convenient arrangement for attachment in order to facilitate attachment and removal of the top part 16. Alternatively, the top part of the filter holder 7 may rest on top of the filter without being physically attached. Similarly, the pillar 5 may be provided with a pin with threads 18 such that it may be screwed into the bottom part 2 of the dispenser 1. Other alternatives are, however, possible. For example, the pin 18 may be smooth and dimensioned to fit snugly inside a corresponding hole in the bottom part 2 of the dispenser such that it keeps the pillar 5 centered inside the cylinder 4, while it is possible to simply pull it out when the top part 16 and the filter 15 and filter holder 7 are removed. Yet another alternative is to simply keep the pillar cylindrical and provide the bottom part 2 of the dispenser 1 with a socket or recess into which the pillar 5 fits.

The pillar 5 does not necessarily have to be cylindrical, and other cross sectional shapes, for example square, may be contemplated. Alternative shapes may introduce additional motion in the water while it is circulating inside the chamber 3.

The various parts of the dispenser 1, at least all the parts that come into direct contact with the water, should be manufactured from materials that are suitable for coming into contact with food and drink, for example glass, metal and plastics that are approved for such use. Furthermore, making the pillar 5 from a material that has low magnetic permeability ensures that the pillar does not interfere with the magnetic fields provided by the magnets 6.

The choice of magnets 6 may be adapted in accordance with design criteria, for example in order to experiment with the effects of different strength magnetic fields on water. Neodymium magnets have a magnetic flux density of at least 0.9 Tesla (9000 Gauss), and often as high as 1,3 T (13,000 G), and using magnets with an approximate size of 20 mm diameter and 10 mm height is believed to be appropriate for subjecting all the water in the dispenser with a sufficiently strong magnetic field in order to have an effect on water clusters, provided that the inner diameter of the cylinder 4 is approximately 70 mm. Two magnets of the size described above and with a hole through the middle can be attached to each other using e.g. screws. It is, of course, consistent with the principles of the invention to use additional magnets, either close together or spaced apart. The screw and nut and any washers or discs placed above, between and below the magnets 6, may be made from a non-magnetic material, for example plastic, nylon or austenitic stainless steel, in order to avoid interference with the magnetic field.

The height of the dispenser may be anything that is considered convenient, for example between 150 mm and 250 mm. The volume of the part of the chamber 3 where the magnetic field is strong enough to be likely to influence the presence of water clusters, and the rate of flow measured in volume of water per unit of time, may influence the amount of time the water is subjected to the magnetic field. Consequently, rate of flow may be a design criteria for designing different exposure times.

The manufacturing of the various parts can be done using any method known in the art, based on the material used for production of the respective part, including injection molding, machining, milling, lathing and other suitable methods.

Various modifications to the design described above are possible within the scope of the invention. For example, the cylinder 4 could be made as an integral part with the bottom part 2, the top part 16, or both. As such, when the present disclosure and the appended claims refer to these parts the reference is intended to cover the parts as individual components as well as the parts as different segments or sections of the same component. The same applies to other components. For example could the jet or nozzle 10 be a separate component mounted in the bottom part 2 of the dispenser 1, or it could be an integral part of the bottom part 2.

It must be understood that all terms indicative of relative position or direction, for example upper, lower, top, bottom, upward, vertical, horizontal, above, below, up and down, are intended to describe the various parts or components position relative to each other given a specific orientation of the dispenser 1. The dispenser 1 may equally well be oriented differently, for example horizontally or with the water flowing into the dispenser at the top and out at the bottom, and the use of the above mentioned terms is not intended to exclude such alternatives. Instead, the terms must be thought of as defining positions relative to the direction of the flow of water, where the end at which the water enters the dispenser is defined as lower or bottom part, and the end at which the water leaves the dispenser is defined as an upper or top part, irrespective of which—if any—of these parts is actually positioned higher than the other.

1. A water dispenser for magnetic treatment of water, comprising:
a cylinder (4) defining a chamber (3);
a bottom part (2) with an opening for leading water into the chamber (3);
a central pillar (5) inside the cylinder (4) reaching upward from the bottom part (2);
one or more magnets (6) inside the central pillar (5); and
a top part (16) with an opening for leading water that has passed through the filter (15) out of the dispenser (1)
wherein the opening in the bottom part (2) includes a nozzle (10) with a direction that is sufficiently close to horizontal and to being parallel to the walls of the cylinder (4) to cause water to rotate inside the cylinder (4) when it streams into the chamber (3).

2. The water dispenser of claim 1, wherein the one or more magnets (6) are two magnets positioned adjacent to each other in the vertical direction with the same polarity facing each other.

3. The water dispenser of claim 1, wherein the diameter of the nozzle (10) is dimensioned to allow formation of gas bubbles in the water inside the chamber (3) as a result of the drop in pressure from one side of the nozzle (10) to the other.

4. The water dispenser of claim 1, further comprising a filter holder (7) positioned on top of the pillar (5) and configured to hold a filter (15).

5. The water dispenser of claim 4, wherein the filter holder (7) is configured to allow water to pass through the filter (15) and towards the opening in the upper part (16) of the dispenser (1).

6. The water dispenser of claim 5, wherein the filter holder (7) is configured to hold a cylindrical filter (15) between an upper part of the filter holder (7) and a lower part of the filter holder (7) such that water passes from the outside of the cylindrical filter (15) to the inside of the cylindrical filter (15), and wherein an opening of the upper part of the filter holder (7) is aligned with the inside of the cylindrical filter (15) and with the opening in the upper part (16) of the dispenser (1).

7. The water dispenser of claim 1, wherein the upper part (16) of the dispenser (1) is releasably attached to the cylinder (4) and the cylinder is releasably attached to the bottom part (2) of the dispenser (1).

8. The water dispenser of claim 1, wherein the pillar (5) is releasably attached to the bottom part (2) of the dispenser (1) by a method selected from the group consisting of: a threaded pin (18) that can be screwed into the bottom part (2), a smooth pin (18) that can be entered into a corresponding hole in the bottom part (2), and a socket in the bottom part (2) configured to receive the pillar (5).

9. The water dispenser of claim 1, wherein the upper part of the pillar (5), above the magnets (6), is provided with one or more openings (13) leading into an interior room (14) such that any content inside the interior room (14) will be in contact with the water in the chamber (3).

10. The water dispenser of claim 1, further comprising a spout (8) connected to the opening in the upper part (16) of the dispenser (1).
